(19) United States
(12) Patent Application Publication
(10) Pub. No.: US 2018/0019702 A1
(43) Pub. Date: Jan. 18, 2018

(54) HYBRID GANGED HELIOSTAT

(71) Applicant: SKYSUN LLC, Bay Village, OH (US)

(72) Inventor: James Joseph CLAIR, Bay Village, OH (US)

(21) Appl. No.: 15/546,148

(22) PCT Filed: Jan. 27, 2016
(86) PCT No.: PCT/US16/15084

§ 371 Date: Jul. 25, 2017

Related U.S. Application Data
(60) Provisional application No. 62/108,735, filed on Jan. 28, 2015.
(60) Provisional application No. 62/179,020, filed on Apr. 27, 2015.
(60) Provisional application No. 62/230,964, filed on Jun. 22, 2015.

(51) Int. Cl. H02S 40/22; F24J 2/10; F16M 11/06; F24J 2/54; F24J 2/52

(52) U.S. Cl. CPC H02S 40/22; F24J 2/1052; F16M 11/06; F24J 2002/5286; F24J 2002/5458; F24J 2002/1085

(57) ABSTRACT

A method of utilizing solar radiation as a solar radiation source moves throughout the day includes providing a deformable surface having a pair of opposing edges and supporting the opposing edges of the deformable surface with a pair of flexible members. The method also includes imparting a curvature on the deformable surface to cause incident rays to be coincident with the normal axis of the deformable surface. The method further includes changing the curvature of the deformable surface as the solar radiation source moves throughout the day, such that the curvature corresponds to a location of the solar radiation source.

### REFERENCE TO RELATED APPLICATIONS

This application claims an invention which was disclosed in Provisional Applications No. 62/108,735, filed Jan. 28, 2015, entitled “ELECTROMAGNETIC CONCENTRATOR WITH HYBRID HELIOSTATS”, 62/179,020, filed Apr. 27, 2015, entitled “ELECTROMAGNETIC CONCENTRATOR WITH HYBRID HELIOSTATS AND WITHOUT FLEXIBLE MEMBER TENSION ADJUSTMENT” and 62/230,964, filed Jun. 22, 2015, entitled “CSP GANGED HELIOSTAT TECHNOLOGIES”. The benefit under 35 USC §119(e) of the United States provisional application is hereby claimed, and the aforementioned applications is hereby incorporated herein by reference. This application is related to U.S. Pat. No. 8,609,979, filed Feb. 22, 2011 and application Ser. No. 14/104,666, filed Dec. 12, 2013

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not Applicable

### TECHNICAL FIELD

The nature of the invention relates to tracking devices of electromagnetic radiation, and especially as a system where solar radiation may be concentrated, redirected or utilized as in systems such as, but not limited to, concentrating solar power, photovoltaic power or concentrating photovoltaic power.

### BACKGROUND ART

The present invention pertains generally to optical/mechanical systems designed to utilize electromagnetic radiation. Specifically, the system concentrates, redirects or utilizes solar radiation for useful purposes.

Many patents exist which seek to decrease cost and complexity of solar power systems.

It is therefore an object of xe invention to provide a solar power system, or portion thereof, that is economical to construct.

It is another object of the invention to provide a solar power system that has a large collecting area.

It is a further object of the invention to concentrate obliquely incident solar radiation falling upon a ganged heliostat reflector.

It is a further object of the invention to align multiple solar panels so that the panel's normal axes are parallel to the solar radiation falling upon the solar panels.

It is a further object of the invention to demonstrate economical deployment in or on rough terrain.

### DESCRIPTION OF RELATED ART

Patent Numbers and Application numbers:

U.S. Pat. No. 8,609,979, Clair et al, Feb. 22, 2011, Ser. No. 14/104,666 Clair et al, Dec. 12, 2013, TABLE-US-00001 20100195227 Green, Steven Russell 20080168981 Cummings, et al U.S. Pat. No. 7,192,146 Gross, et al March 2007 U.S. Pat. No. 6,541,694 Winston, et al April 2003 U.S. Pat. No. 5,755,217 Stirbl, et al May 1998 U.S. Pat. No. 5,540,216 Rasmussen, et al July 1996 U.S. Pat. No. 4,634,276 Sharpe, et al January 1987 U.S. Pat. No. 4,608,964 Russo, et al September 1986 U.S. Pat. No. 4,552,438 Murphy, et al November 1985 U.S. Pat. No. 4,466,423 Dolan, et al August 1984 U.S. Pat. No. 4,214,163 Namae, et al July 1980 U.S. Pat. No. 4,173,397 Simpson, et al November 1979 U.S. Pat. No. 4,162,825 Dowty, et al July 1979 U.S. Pat. No. 3,574,447 Ruble, et al April 1971

### RELATED LITERATURE

R W Hosken, Applied Optics Vol. 46, No. 16, June 2007 p. 3107 re: Circle of Least Confusion Bennett and Labbett, Clinical Visual Optics, p. 81, Elsevier Health Science, 1998 M. Born, E. Wolf, Principles of Optics, Pergamon, 6.sup.th Ed. 1980 G. S. Monk, Light, Principles and Experiments, NY. Dover, 2.sup.nd Ed. Appdx. III p. 424, 1963 G. A. Rottigni, Concentration of the sun's rays using catenary curves, Applied Optics Vol. 17, No. 6, March 1978 A. P. Smirnov, Journal of Optics and Spectroscopy, Vol. 101, No. 3, September 2006

### SUMMARY OF THE INVENTION

In one embodiment, a method is provided for concentrating solar radiation from a moving solar radiation source onto a separately disposed receiver as the moving solar radiation source moves throughout the day. The method includes providing a deformable reflective surface having a pair of opposing edges and supporting the opposing edges of the deformable reflective surface with a pair of flexible members. The method further includes imparting a curvature on the deformable reflective surface to reflect rays from the moving solar radiation source to a receiver, and to focus the reflected rays to reduce astigmatism caused by the incidence of solar radiation upon the deformable surface. The method also includes changing the curvature of the deformable reflective surface as the moving solar radiation source moves throughout the day. The changing steps are taken from the group consisting of (a) orienting the opposing edges of the deformable reflective surface at differing rotational orientations, (b) individually tensioning the flexible members supporting the opposing edges of the deformable surface at different tensions and (c) orienting the opposing edges of the deformable reflective surface at differing rotational orientations and individually tensioning the flexible members supporting the opposing edges of the deformable surface at different tensions.

In another embodiment, a method of utilizing solar radiation as a solar radiation source moves throughout the day includes providing a deformable surface having a pair of opposing edges and supporting the opposing edges of the deformable surface with a pair of flexible members. The method also includes imparting a curvature on the deformable surface to cause incident rays to be coincident with the normal axis of the deformable surface. The method further includes changing the curvature of the deformable surface as the solar radiation source moves throughout the day, such that the curvature corresponds to a location of the solar radiation source. The shaping steps are taken from the group consisting of (a) orienting the opposing edges of the deformable surface at differing rotational orientations. (b) individually tensioning the flexible members supporting the opposing edges of the deformable surface at different tensions, and (c) orienting the opposing edges of the deformable surface at differing rotational orientations and individually tensioning the flexible members supporting the opposing edges of the deformable surface at different tensions, these orientations and tensions changing throughout the day to correspond to the solar radiation source.

In yet another embodiment, a system for utilizing solar radiation includes a deformable surface having a pair of opposing edges and a pair of flexible members supporting the opposing edges of the deformable surface, each flexible member having a first end and a second end. The system also includes a first hub having a first tensioning mechanism connected to the first ends of the pair of flexible members, the first hub being rotatable about an axis substantially parallel to the pair of flexible members. The system further includes a second hub having a second tensioning mechanism connected to the second ends of the pair of flexible members, the first hub being rotatable about an axis substantially parallel to the pair of flexible members. The first and second hub are configured to change a curvature of the deformable surface by rotating about the axis substantially parallel to the pair of flexible members. The first and second tensioning mechanisms are configured to change a curvature of the deformable surface by adjusting a tension of at least one of the flexible members.

### BRIEF DESCRIPTION OF DRAWINGS

The following is description of an exemplary embodiment of the invention, wherein:

FIG. 1 is a perspective view of a ganged heliostat support and adjusting mechanism;

FIG. 2 is a perspective view of a hybrid heliostat mechanism which operates in conjunction with the ganged heliostat mechanism;

FIG. 3 is an elevation view of the ganged heliostat;

FIG. 4 is a plan or top view of the ganged heliostat.

### DETAILED DESCRIPTION

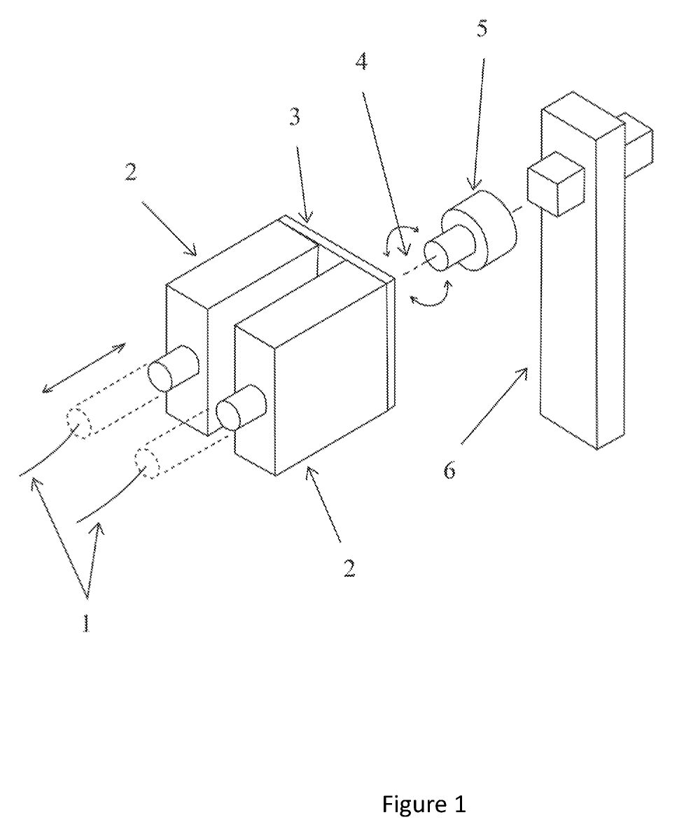

FIGS. 1-4 illustrate one embodiment of a ganged heliostat. Multiple components act in concert to shape a reflective surface so as to concentrate obliquely incident solar radiation.

In one embodiment the ganged heliostat may shape a reflective surface so as to concentrate obliquely incident solar radiation at a fixed receiver diurnally, or the same mechanism or portion thereof, may orient multiple solar panels so that each panel face is perpendicular the incident radiation diurnally. The solar panels may redirect radiation to be utilized elsewhere. The reflective surface may be a continuous flexible sheet, or a plurality of flat reflectors. The reflective surface is supported by flexible members such as cables. The members would hang freely between supports located at, or near the member's endpoints. The overall surface generated by the flexible members would be a portion of a catenary of revolution or catenoid laying principally in the horizontal with the reflective surface facing up. A shallow catenoid approximates the surface of a sphere. Obliquely incident radiation striking a sphere-like reflector is concentrated at the astigmatic foci. Deformation of the flexible members changes the orientation and shape of the reflective surface. Deformation of the flexible members may be accomplished by varying the flexible member tension which may be combined with rotation of the flexible member endpoints about an axis principally horizontal, parallel to and in line with the flexible members. Additionally, each facet of the reflective surface may rotate about an axis in line with the facet and perpendicular to the flexible members.

For concentrating solar power applications, the deformation is such that radiation reflected is concentrated at the center of a chosen astigmatic focal zone. Essentially the deformation imposes a crossed cylinder warp, or toric contour on the reflective surface, correcting astigmatic aberration. Rotational variation of individual reflectors improves system accuracy and concentration level. The reflecting surface concentrates solar radiation at the receiver. The receiver may be fixed and placed to receive the concentrated radiation. The receiver may be tracking, such that the receiver moves to always be at the focal zone(s) as it tracks the reflected solar radiation through the day. By these means a cost efficient and large ganged heliostat may be achieved. A plurality of the ganged heliostats may concentrate solar radiation in unison. The plurality of ganged heliostats may be arranged end to end, side by side or both. Enabling the sharing of system infrastructure and reducing cost. The plurality of ganged heliostats arranged both end to end and side by side may have application in concentrating solar power (CSP) power tower style systems. The plurality of ganged heliostats arranged primarily side by side may concentrate collectively to a line focus having applications in CSP trough style systems.

For photovoltaic or concentrating photovoltaic applications each of the individual heliostats of the ganged heliostat may oriented by the invention so that all individual heliostat surfaces are simultaneously parallel to each other and perpendicular to the radiation source. Continued deformation by the invention may maintain this orientation as the radiation source moves throughout the day. For photovoltaic (PV) applications less infrastructure may be used due to relaxed requirements of orientation accuracy while still achieving nearly all the performance benefits of fully tracking dual axis style systems.

Another application of the above described orientation, where each heliostat surface is simultaneously parallel to each other and perpendicular to the radiation source, has main heliostat surfaces which are reflective and concave in shape. These concave reflectors have secondary optics, such as a convex reflector, placed near each of the concave reflector's focal area where both concave reflector and secondary optic share a common normal axis. Given above, that this normal axis may coincide with the radiation source, each heliostat of the ganged heliostat would produce a collimated beam output. This output may be steered by a tertiary reflector, one per heliostat, to redirect the output to a receiver. The receiver may be at or near ground level. Although more complex, such a system would have benefits of eliminating the need for a receiver tower and being capable of a narrow input angle into the receiver reducing radiative loss.

Applications above describing the utilization of flat reflectors should not be construed as limiting. Reflectors may be flat or reflectors could be a plurality of flat reflectors held in a reflector cell designed to angle the flat reflectors so that a relatively shallow concave reflector is approximated. The angle of this canting being optimized for system size and distance to receiver so that concentration is further increased.

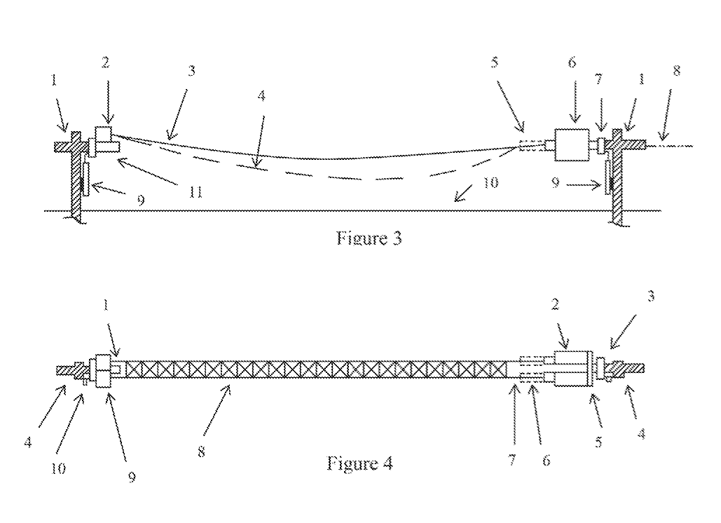

Referring to FIG. 3. support posts 1 are firmly attached to the earth or ballasted for rigidity. Support posts 1 carry hubs 7 and 11. Hubs 7 and 11 may rotate about rotational axis 8. Hubs 7 and 11 may be internally or externally actuated. External actuators 9 are depicted. Hub 7 carries cable tensioning mechanism 6, here depicted as two linear actuators where dashed lines 5 show travel of the cable tensioning mechanism 6. One end of the cables 3, or dashed line cable 4, attach to cable tensioning mechanism 6. Cables 3 depicts tauter cables than cables 4. The cables 3 or cables 4 carry the deformable surface. The other end of cables 3 or cables 4 attach to block 2 which is attached to hub 11. Grade 10 is shown for reference.

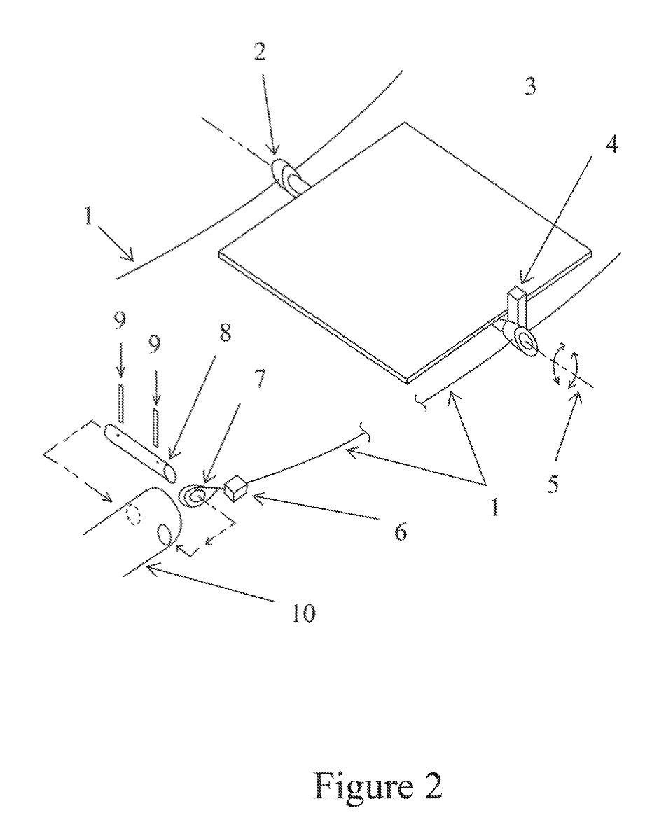

Referring to FIG. 4, support posts 4 are firmly attached to the earth or ballasted for rigidity. Support posts 4 carry hubs 3 and 9. Hubs 3 and 9 may rotate about a rotational axis parallel to the long axis of the invention to and coincident with the rotational axes of hubs 3 and 9. Hubs 3 and 9 may be internally or externally actuated. One external actuator 10 is depicted. Plate 5 attaches cable tensioning mechanism 2 to hub 3. Cable tensioning mechanism 2, here depicted as two linear actuators where dashed lines 6 show travel of the cable tensioning mechanism 2. Proximate ends of cable 1 and cable 7 attach to cable tensioning mechanism 2. The opposing ends of cable 1 and cable 7 attach to hub 9. Cable 1 and cable 7 carry solar panels 8, twenty-four of which are shown. Each of the solar panels 8 may rotate about an axis perpendicular to and in a line with cable 1 and cable 7. The rotation of the solar panels 8 is detailed in FIG. 2.

Independent variation of cable tension, hub rotational orientation and solar panel rotation, or a partial combination thereof, imposes a toric shape to the surface defined by the solar panels. Appropriate toric shapes may allow either obliquely incident radiation reflected by the solar panels to be concentrated at a separate and fixed receiver, or orient all solar panels such that each panel's normal axis is coincident with radiation source so as to enhance photovoltaic performance or to redirect the radiation for use elsewhere. A ganged heliostat as described herein allows for utilization of solar energy with reduced cost and infrastructure. Control means may be open or closed loop in method. Control may be of a CPU logic circuit to maximize performance.

Referring to FIG. 2, cables 1 support a plurality of solar panels 3, one of which is shown, by means of panel support bar 2. Panel support bar 2 attaches to cables 1, where attachment may be fixed or allow limited movement such as a cable passing through a tube where cable diameter is less than tube diameter. Solar panels 3 may rotate about rotational axis 5. Actuation of the solar panels 3 is accomplished by actuator 4. Cables 1 terminate to cable eye 7 and are held in place by swage block 6. Retaining pin 8 passes through cable eye 7 and cable tension mechanism 10 and is kept in place with cotter pins 9.

Referring to FIG. 1, Cables 1 attach to cable tensioning mechanism 2. Dashed lines and double headed arrow describe action of cable tensioning mechanism 2. Cable tensioning mechanism 2 is comprised of two actuators, one per cable to vary cable tension independently. Cable tensioning mechanism 2′s actuators attach to plate 3 which attaches to hub 5. Hub 5 allows plate 3 and cable tensioning mechanism 2 to rotate about rotational axis 4. The non-rotating end of hub 5 is attached to post 6.

Accordingly, it is to he understood that the embodiments of the invention herein described are merely illustrative of the application of the principles of the invention. Reference herein to details of the illustrated embodiments is not intended to limit the scope of the claims, which themselves recite those features regarded as essential to the invention. The scope of the invention should not be construed as limited to solar applications.

### INDUSTRIAL APPLICABILITY

The invention described herein has applications in solar thermal power, Concentrating Solar Power (CSP), Solar Photovoltaic and Concentrating Photovoltaic power (CPV). Given a CPV or CSP plant's use of many thousands of individual heliostats, substantial cost savings can be gained by use of the described invention. The invention eliminates the needs for each panel to have a support post of some type. The invention eliminates the need for a dual axis drive for each heliostat.

For Photovoltaic (PV) applications the reduced costs are likely to be more pronounced given the lower accuracy requirements for PV, as opposed to CSP or CPV. Elimination of some elements of the inventions degrees of freedom can still provide a ganged heliostat with accuracy acceptable to typical fully tracking PV applications at a further reduced cost structure.

The invention, a cost effective and scalable heliostat, likely has other applications such as but not limited to solar desalinization and astronomy.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or 265 claims, it is intended to mean not only “directly connected to,” but also “indirectly connected to” such as connected through another component or components.

While the present disclosure has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the disclosure, in its broader aspects, is not limited to the specific details, the representative system and method, and illustrative examples shown and described. Accordingly, departures may be made from such details without departing from the spirit or scope of the applicant's general inventive concept.

What is claimed is:

1. A method of concentrating solar radiation from a moving solar radiation source onto a separately disposed receiver as the moving solar radiation source moves throughout the day, the method comprising:
providing a deformable reflective surface having a pair of opposing edges;
supporting the opposing edges of the deformable reflective surface with a pair of flexible members;
imparting a curvature on the deformable reflective surface to reflect rays from the moving solar radiation source to a receiver, and to focus the reflected rays to reduce astigmatism caused by the incidence of solar radiation upon the deformable surface; and
changing the curvature of the deformable reflective surface as the moving solar radiation source moves throughout the day, wherein the changing steps are taken from the group consisting of
(a) orienting the opposing edges of the deformable reflective surface at differing rotational orientations, (b) individually tensioning the flexible members supporting the opposing edges of the deformable surface at different tensions and (c) orienting the opposing edges of the deformable reflective surface at differing rotational orientations and individually tensioning the flexible members supporting the opposing edges of the deformable surface at different tensions.

2. A method as set forth in claim 1, wherein the deformable reflective surface comprises a plurality of reflectors each rotatable about an axis perpendicular to the supporting flexible members.

3. A method as set forth in claim 2, wherein the imparting steps comprise rotating at least one of the plurality of reflectors about its axis at various angles throughout the day to correspond to the solar radiation source.

4. A method as set forth in claim 2, wherein the receiver is stationary throughout the day.

5. A method set forth as in claim 1, comprising the step of moving the receiver throughout the day in a manner corresponding to the changing curvatures of the deformable reflective surface.

6. A method as set forth in claim 1, wherein the flexible members hang freely between vertical supports.

7. A method as set forth in claim 1, wherein the deformable reflective surface comprises at least one row of a plurality of reflectors.

8. A method as set forth in claim 7, wherein each of the plurality of reflectors are flat and rigid.

9. A method as set forth in claim 8, wherein the plurality of reflectors are arranged end-to-end in a direction parallel to the flexible members.

10. A method of utilizing solar radiation as a solar radiation source moves throughout the day, the method comprising:
providing a deformable surface having a pair of opposing edges;
supporting the opposing edges of the deformable surface with a pair of flexible members;
imparting a curvature on the deformable surface to cause incident rays to be coincident with the normal axis of the deformable surface and
changing the curvature of the deformable surface as the solar radiation source moves throughout the day, such that the curvature corresponds to a location of the solar radiation source, wherein the shaping steps are taken from the group consisting of
(a) orienting the opposing edges of the deformable surface at differing rotational orientations, (b) individually tensioning the flexible members supporting the opposing edges of the deformable surface at different tensions, and (c) orienting the opposing edges of the deformable surface at differing rotational orientations and individually tensioning the flexible members supporting the opposing edges of the deformable surface at different tensions, these orientations and tensions changing throughout the day to correspond to the solar radiation source.

11. A method as set forth in claim 10, wherein the deformable surface comprises a plurality of solar panels each rotatable about an axis perpendicular to the supporting flexible members.

12. A method as set forth in claim 11, wherein the imparting steps comprise rotating the solar panels at various angles throughout the day to correspond to the solar radiation source.

13. A method as set forth in claim 12, wherein the imparting steps align the normal axis of each solar panel to be coincident with the solar radiation source.

14. A method as set forth in claim 13, wherein the solar panels are of a photovoltaic nature.

15. A method as set forth in claim 13, wherein the solar panels redirect solar radiation.

16. A method as set forth in claim 15, wherein each the solar panel redirects solar radiation to the same location.

17. A system for utilizing solar radiation comprising:
a deformable surface having a pair of opposing edges;
a pair of flexible members supporting the opposing edges of the deformable surface, each flexible member having a first end and a second end;
a first hub having a first tensioning mechanism connected to the first ends of the pair of flexible members, the first hub being rotatable about an axis substantially parallel to the pair of flexible members;
a second hub having a second tensioning mechanism connected to the second ends of the pair of flexible members, the first hub being rotatable about an axis substantially parallel to the pair of flexible members,
wherein the first and second hub are configured to change a curvature of the deformable surface by rotating about the axis substantially parallel to the pair of flexible members, and
wherein the first and second tensioning mechanisms are configured to change a curvature of the deformable surface by adjusting a tension of at least one of the flexible members.

18. The system of claim 17, wherein the deformable surface is a reflective surface.

19. The system of claim 18, further comprising a receiver configured to receive 375 light reflected by the deformable surface.

20. The system of claim 17, wherein the deformable surface is configured to absorb solar radiation.
